(19) United States
(12) Patent Application Publication
(10) Pub. No.: US 2008/0286516 A1
(43) Pub. Date: Nov. 20, 2008

(54) Label sticker

(76) Inventor: Chiu-Hsiang Lee, Taipei City (TW)

Correspondence Address: Troxell Law Office Pllc, Suite 1404, 5205 Leesburg Pike, Falls Church, VA, 22041, US

(21) Appl. No.: 11/798,784

(22) Filed: May 16, 2007

(51) Int. Cl. B32B 9/00

(52) U.S. Cl. 428/41.8

(57) ABSTRACT

An improved structure for a label sticker, mainly including a base paper, a rear surface of which is coated with adhesive material, and a front surface provides for printing characters or trademark patterns thereon, and two papers that provide for writing or printing thereon. Rear surfaces of the two papers are coated with one-time adhesive material to enable affixing to the base paper in juxtaposition to each other, thereby structuring a label sticker. After writing or printing sender and addressee information on the two papers, the base paper is affixed to a goods packing box, and an addressee signs the paper after receipt thereof, whereupon the two papers are peeled away from the base paper to serve as a receipt and a signed copy to facilitate future checking of accounts while the retained base paper achieves advertising effectiveness, thereby providing the label sticker with greater convenience of use and practicability.

### BACKGROUND OF THE INVENTION

(a) Field of the Invention

The present invention relates to an improved structure for a label sticker, and more particularly to a label sticker that can be affixed to a packing box to enable writing sender and addressee information thereon, as well achieving use as a receipt and a signed copy and providing advertising effectiveness.

(b) Description of the Prior Art

In general, when mailing or transporting goods, operating personnel generally affix a label sticker to the goods packing box with sender and addressee information written thereon to facilitate identification by a delivery person, and after delivering the goods to the addressee, then the addressee signs another receipt book to acknowledge receipt of the goods, whereafter the signed receipt is torn off and given to the addressee, and the delivery person retains a copy of the signed receipt to facilitate future checking of accounts. Such a conventional procedure is not only troublesome, wastes a lot of time and effort and lacks working efficiency, moreover, a disorderly written label sticker affixed to the packing box impairs appearance and impression, and thus not ideal. In light of this, the inventor of the present invention, having accumulated years of experience in related arts, and through continuous research and experimentation, has endeavored to provide an improved structure for a label sticker with greater convenience of use, and improves practicability.

### SUMMARY OF THE INVENTION

A primary objective of the present invention is to provide an improved structure for a label sticker that enables writing sender and addressee information thereon, in addition to affording use as a receipt and a signed copy and providing advertising effectiveness.

The aforementioned improved structure for a label sticker comprises a base paper, a rear surface of which is coated with adhesive material, and a front surface provides for printing characters or trademark patterns thereon, and two papers that provide for writing or printing thereon. Rear surfaces of the two papers are coated with one-time adhesive material to enable affixing to the base paper in juxtaposition to each other, thereby structuring a label sticker, and after respectively writing or printing sender and addressee information on the two papers, the base paper is affixed to a goods packing box. An addressee signs the paper to acknowledge receipt, and the two papers are respectively peeled away from the base paper to serve as a receipt and a signed copy to facilitate future checking of accounts, while the retained base paper achieves advertising effectiveness, thereby providing the label sticker with greater convenience of use and practicability.

The adhesive material coated on rear surfaces of the two papers of the aforementioned improved structure for a label sticker is a one-time adhesive glue material, thereby enabling the two papers to have no adhesiveness after being peeled away from the base paper to facilitate carrying and retaining thereof.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view according to the present invention.

FIG. 2 shows an exploded elevational view according to the present invention.

FIG. 3 shows an elevational view of the present invention affixed to a packing box.

FIG. 4 shows an elevational view of an embodiment of the present invention in use.

FIG. 5 shows an elevational view of the embodiment of the present invention in use.

### DETAILED DESCRIPTION OF THE PREFERRED EMBODIMENTS

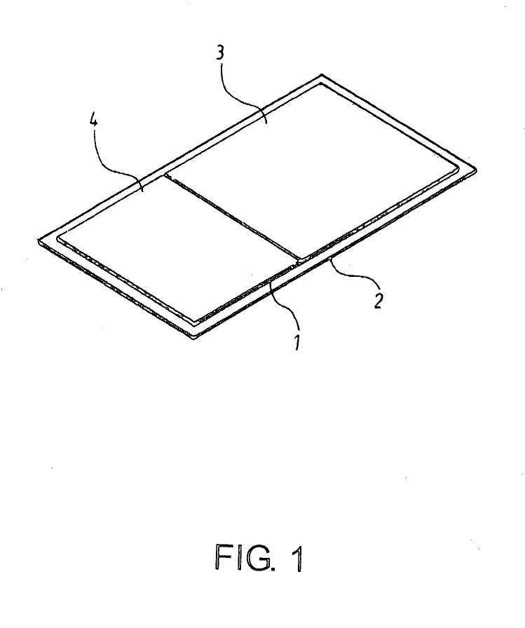

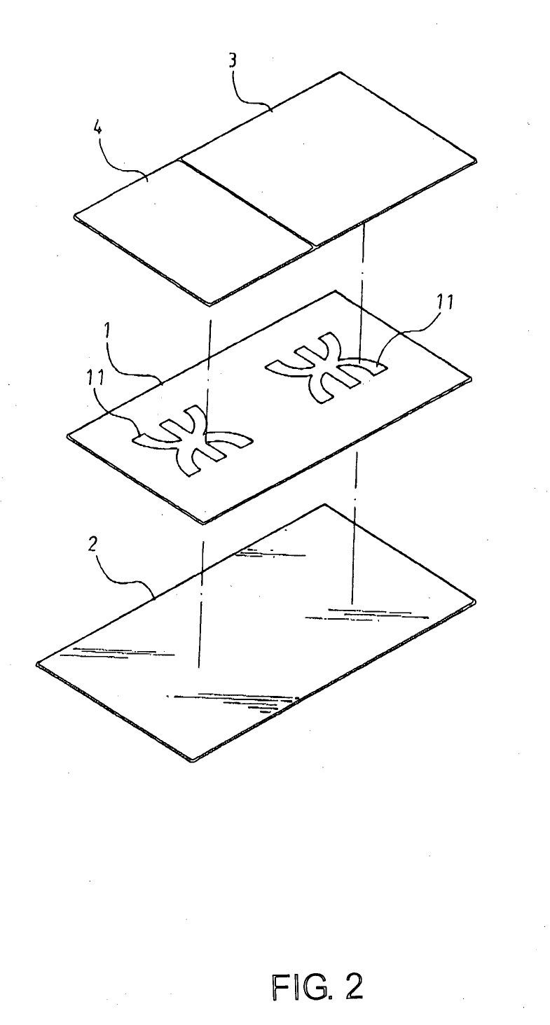

Referring to FIG. 1 and FIG. 2, which show an elevational view and an exploded elevational view of the present invention respectively, wherein the present invention comprises a base paper 1, a front surface of which has characters or trademark patterns 11 printed thereon (for instance, an embodiment of the present invention has manufacturer trademarks), a rear surface of the base paper 1 is coated with adhesive material to enable adhering to a release paper 2, and two papers 3, 4 that provide for writing or printing thereon, rear surfaces of which are coated with a one-time adhesive material to enable affixing to the base paper 1 in juxtaposition to each other.

Accordingly, assembly of the aforementioned component members constitutes a label sticker, and after respectively writing or printing sender and addressee information on the two papers 3, 4, the base paper 1 is peeled away from the release paper 2 and affixed to a goods packing box. Upon delivery of the goods, the addressee signs the paper 3 to acknowledge receipt, and the two papers 3, 4 are respectively peeled away from the base paper 1 to serve as a receipt and a signed copy to facilitate future checking of accounts, while the retained base paper 1 achieves advertising effectiveness, thereby providing the label sticker with greater convenience of use and practicability.

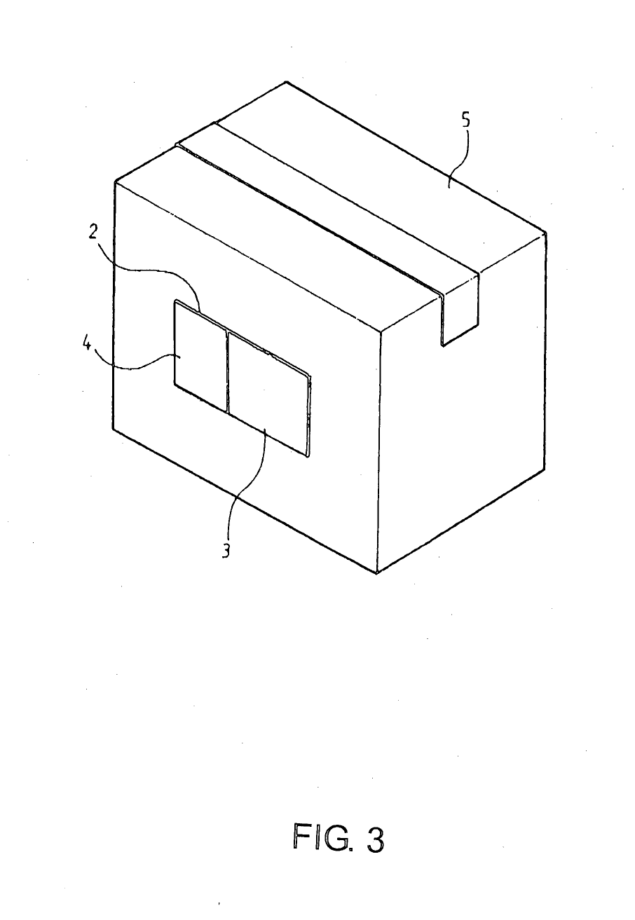

Referring to FIG. 3, which shows an elevational view of the present invention affixed to a packing box, wherein when using the present invention, after sender and addressee information are respectively written or printed on the two papers 3, 4, the base paper 1 is peeled away from the release paper 2 and affixed to a goods packing box 5, thereby clearly displaying information for delivery of the goods and facilitating identification by a delivery person.

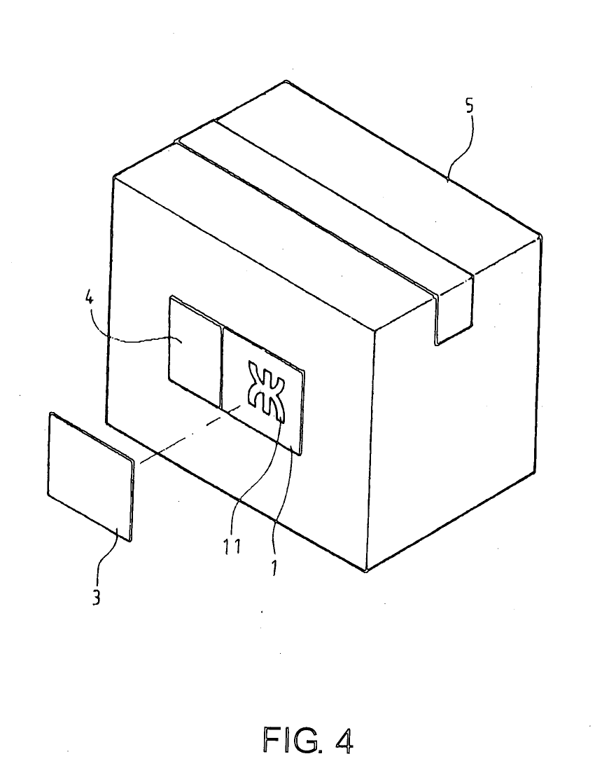

Referring to FIG. 4, which shows an embodiment of the present invention in use, wherein after a delivery person has delivered the goods to its destination, the addressee signs for receipt of the goods directly on the paper 3, and the delivery person peels and takes away the signed paper 3 from the base paper 1 for use as a receipt that the goods have been received and future checking of accounts. Because the adhesive material coated on the rear surface of the paper 3 is a one-time adhesive glue material, thus, the paper 3 no longer has any adhesiveness after being peeled away from the base paper 1, thereby facilitating carrying and retaining of the paper 3.

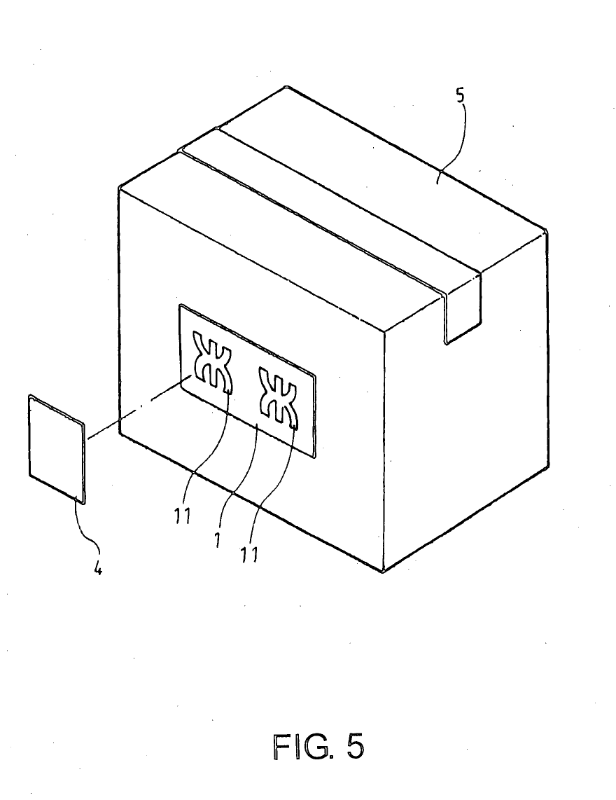

Referring to FIG. 5, which shows the embodiment of the present invention in use, wherein after a delivery person has delivered the goods to its destination, the addressee can peel away the other paper 4 from the base paper 1 to serve as a receipt and bill for future payment, similarly, because the adhesive material coated on the rear surface of the paper 4 is a one-time adhesive glue material, thus, the paper 4 no longer has any adhesiveness after being peeled away from the base paper 1, thereby facilitating retaining and consulting the paper 4.

After peeling away the aforementioned papers 3, 4, the base paper 1 displays the characters, trademark patterns 11 printed thereon, thereby enabling the base paper 1 to achieve advertising effectiveness, and further providing the label sticker with greater practicability.

In conclusion, the present invention provides the papers 3, 4 that can be written or printed on, which in conjunction with the base paper 1 having characters or trademark patterns printed thereon to constitute the label sticker that achieves use as a receipt and a signed copy and providing advertising effectiveness. The present invention provides a practical and novel design, accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A label sticker, comprising: a base paper, a front surface of which has characters or trademark patterns printed thereon, and a rear surface is coated with adhesive material to enable adhering to a release paper; two papers that provide for writing or printing thereon, rear surfaces of which are coated with adhesive material to enable affixing to a surface of the base paper in juxtaposition to each other; assembly constitutes a label sticker, and after respectively writing or printing sender and addressee information on the two papers, the base paper is peeled away from the release paper and affixed to a goods packing box, and upon delivery of the goods, the addressee signs the paper to acknowledge receipt, and the two papers are respectively peeled away from the base paper to serve as a receipt and a signed copy to facilitate future checking of accounts, while the retained base paper achieves advertising effectiveness, thereby providing the label sticker with greater convenience of use and practicability.

2. The label sticker according to claim 1, wherein the adhesive material coated on rear surfaces of the two papers is a one-time adhesive glue material, thereby enabling the two papers to have no adhesiveness after being peeled away from the base paper to facilitate carrying and retaining thereof.
